(19) United States
(12) Patent Application Publication
(10) Pub. No.: US 2014/0076819 A1
(43) Pub. Date: Mar. 20, 2014

(54) Magnetically Separable Synthetic Nanoparticles for Water Treatment

(71) Applicant: The Board of Trustees of the Leland Stanford Junior University, Palo Alto, CA (US)

(72) Inventors: Mingliang Zhang, Fremont, CA (US); Xing Xie, Stanford, CA (US); Shan X. Wang, Portola Valley, CA (US); Craig S. Criddle, Redwood City, CA (US)

(21) Appl. No.: 14/032,033

(22) Filed: Sep. 19, 2013

Related U.S. Application Data
(60) Provisional application No. 61/703,068, filed on Sep. 19, 2012.

(51) Int. Cl. C02F 1/48; C02F 1/74; C02F 1/32

(52) U.S. Cl. CPC C02F 1/48; C02F 1/32; C02F 1/74
USPC 210/695; 252/176

(57) ABSTRACT

New multifunctional synthetic nanoparticles are adapted for water treatment, with environmentally-functional layers, optional capping layers, and synthetic antiferromagnetic cores. With high surface-to-volume ratio, these nanoparticles are very efficient in water treatment, including but not restricted to water disinfection, photo-catalytic degradation, contaminant adsorption, etc., in the context of drinking water or waste water treatment. Meanwhile, their magnetic cores are highly magnetically responsive and can be separated by 99% within 10 min using simply a permanent magnet. Moreover, once some non-degradable chemicals (like perfluorinated compounds) are absorbed to the particle surface, these chemicals can be further degraded by introducing hyperthermia or eddy current heating. These particles can be redispersed after the external magnetic field is removed, and can therefore be used in a regenerative treatment process, substantially reducing the cost while eliminating contaminated byproducts.

### CROSS REFERENCE TO RELATED APPLICATIONS

This application claims the benefit of U.S. provisional patent application 61/703,068, filed on Sep. 19, 2012, and hereby incorporated by reference in its entirety.

### GOVERNMENT SPONSORSHIP

This invention was made with Government support under contract number CA151459 awarded by the National Institutes of Health. The Government has certain rights in this invention.

### FIELD OF THE INVENTION

This invention relates to using magnetic nanoparticles for water treatment.

### BACKGROUND

Access to safe drinking water is extremely important to human beings' health. Currently, water facilities have been built worldwide to provide people in metropolitan areas with high-standard clean water. However, problems still remain in several aspects. First, the drinking water plants are not available in all corners of the world as these plants are usually built in cities with large populations. However, for travelers in natural areas far from civilization or people in countries where sanitation facilities are not so well-developed, a point-of-use water-treating equipment is necessary to provide high-standard drinking water. Second, in the current water-treating technology, chlorine disinfection for instance, undesirable disinfection byproducts have been reported, some of which are carcinogens. Finally, as demand for water resources increases ever more, reuse of waste water after removing contaminants is highly desirable, both ecologically and economically. These driving forces motivate an environment-friendly, regenerative water-treating strategy.

Nanoparticles have been reported to have promising properties for environmental applications. For example, silver nanoparticles can effectively kill bacteria. TiO₂ nanoparticles have photo-catalytic properties and are therefore used to degrade many organic contaminants in water under ultraviolet (UV) light irradiation. Even for non-degradable chemicals, some of them can be removed by adsorption to some metal-oxide nanoparticles. Due to their high surface-to-volume ratio, these particles are much more efficient than their counterparts in bulk form. However, these particles have to be separated from water after the treatment because the toxicity of these nanoparticles is a serious concern. Moreover, the separation step is crucial for regenerative use of these nanoparticles as ideally all of the particles should be separated from water without any loss. In some conventional approaches, these nanoparticles are embedded in a porous matrix in order not to be flushed away with water, but this method sacrifices the effective surface areas of nanoparticles which can react with water contaminants. The porous matrix also increases the capital cost.

Accordingly, it would be an advance in the art to provide improved nanoparticle water treatment.

### SUMMARY

Separating these nanoparticles magnetically is an alternative to avoid the above-described problems, and we hereby disclose multifunctional, magnetically-responsive nanoparticles, and their fabrication and use for water treatment.

Multifunctional, magnetically-responsive nanoparticles are provided to decontaminate water for drinking purposes or for reuse of waste water. Based on the methods described herein, we can make multi-layered nanoparticles with magnetic cores and environmentally-functional surfaces for different water-decontamination purposes. The surfaces can be made up of different materials. In one embodiment, we coat these particles with Ag layers to do water disinfection. In another embodiment, we coat these particles with TiO₂ layers to photo-catalytically degrade organic contaminants. In a third embodiment, we coat these particles with metal-oxide materials to absorb non-degradable contaminants, including perfluorinated compounds (PFCs).

These nanoparticles have multi-layered magnetic cores, which have two ferromagnetic layers separated by a spacer layer. They have negligible remanence and their moments will be saturated when the external field is larger than their saturation field. This is similar to the case of chemically synthesized iron-oxide nanoparticles. However, these multi-layered nanoparticles have at least 10× larger single-particle magnetic moment than conventional iron-oxide nanoparticles, which makes them extremely magnetically responsive. In one embodiment, a NdFeB magnet is placed close to the vial containing particle solution and over 99% of these particles can be separated away within 10 min. Since the toxicities of many kinds of nanoparticles are questionable, the complete removal of these nanoparticles to a level complying with the drinking water standard will have practical significance.

In fact, the complete removal of nanoparticles enables their regenerative use. In one embodiment, particles are recycled after they are used for water treatment. As long as the environmentally-functional surface materials are not consumed, these particles can still work in new cycles. These particles can therefore be used for multiple cycles in water treatment, greatly reducing the overall material cost for water treatment.

In one embodiment, non-degradable chemicals like perfluorinated compounds are adsorbed to synthetic nanoparticles coated with oxides. After the adsorption, we can employ two mechanisms to destroy these molecules by taking the advantage of the magnetic core. In one mechanism, we introduce an alternating magnetic field around these nanoparticles, and because of their failure to keep up with the external field, these particles will generate substantial amount of heat. This mechanism is known as hyperthermia, and the extra energy generated can potentially break the bonds in these non-degradable molecules attaching to the surface of these particles. In another mechanism, the nanoparticles are dried after adsorption, and subsequently subjected to a radio-frequency (RF) electromagnetic field. This generates eddy current flow within the metallic cores of these particles. The eddy current will in turn generate extra heat which can also potentially break the bonds in these non-degradable molecules.

### BRIEF DESCRIPTION OF THE DRAWINGS

FIG. 1 shows a schematic of a synthetic nanoparticle for water treatment.

FIG. 2 shows an example of the hysteresis loop of synthetic nanoparticles measured by alternating gradient magnetometry.

FIG. 3 is a schematic of using Ag-capped synthetic nanoparticles to disinfect water, followed by magnetic separation.

FIG. 4A illustrates the mechanism of the photo-catalytic degradation property of TiO₂.

FIGS. 4B-D show several examples of organic contaminants which can be degraded by TiO₂.

FIG. 5 is a schematic of using TiO₂-capped synthetic nanoparticles to photo-catalytically degrade organic compounds, followed by magnetic separation.

FIGS. 6A-C show a schematic of one-pot treatment of different contaminants simultaneously using a mixture of synthetic nanoparticles.

FIG. 7A-B shows two typical types of PFCs (perfluorinated compounds).

FIG. 7C is a schematic of PFC molecules sticking to the surface of a synthetic nanoparticle.

FIG. 8 shows the percentage of magnetic particles left in the solution vs. separation times for Ag-capped synthetic nanoparticles and iron-oxide nanoparticles.

FIG. 9A is the removal rate in relation to initial concentrations of E. Coli for two nanoparticle dosages.

FIG. 9B is the ratio of active E. Coli left in the solution as a function of nanoparticle dosage for a fixed initial E. Coli concentration.

FIG. 10 shows the effect of water disinfection as a function of treatment cycles in which regenerative use of Ag-capped synthetic nanoparticles is applied.

### DETAILED DESCRIPTION

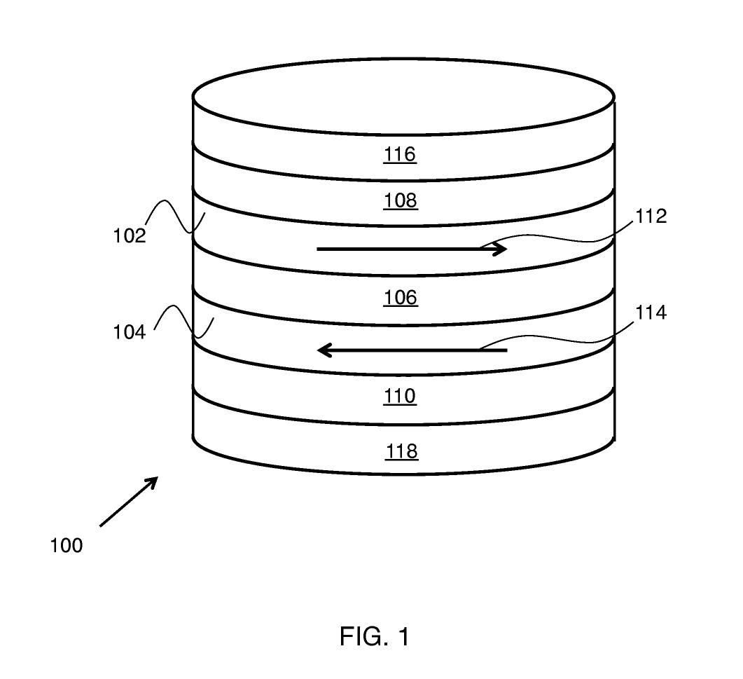

In this work, functionalized synthetic nanoparticles are provided for water treatment. FIG. 1 shows a schematic of a synthetic nanoparticle 100 suitable for this work. This example is a cylindrical stack including multiple layers. Its diameter can range from 50 nm to 200 nm. The layers 102 and 104 are two ferromagnetic layers, which can be Fe or CoFe with their thicknesses ranging from 5 nm to 30 nm. In the absence of an external magnetic field, the moments 112 and 114 of these two layers will align antiparallel to each other, so this structure is a synthetic antiferromagnet. Between layers 102 and 104, there is a spacer layer 106, which can be made of Ti or Ru and preferably has a thickness less than 10 nm. Optionally, on the top and bottom of the two ferromagnetic layers there are two capping layers 108 and 110, which are usually made of Ti, with their thicknesses preferably ranging from 3 nm to 10 nm. The capping layers can prevent the inner ferromagnetic layers from being oxidized and further work as the seeding layer for growing environmentally functional layers. Environmentally functional layers 116 and 118 for water treatment are present on at least one of the two sides of nanoparticle 100. Their materials can be Ag, TiO₂, ZnO, SiO₂, or other metals or metal oxides, and the thickness of each functional layer can range from 10 nm to 50 nm.

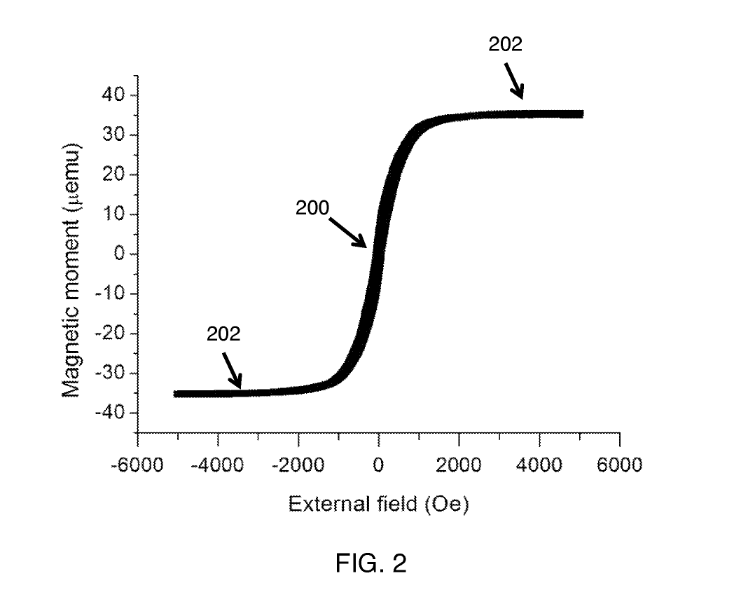

In one embodiment, the synthetic nanoparticles have diameters of 160 nm with their multiple layers in the sequence of Ag 20 nm/Ti 5 nm/Fe 5 nm/Ti 3 nm/Fe 5 nm/Ti 5 nm/Ag 20 nm. Here, the two ferromagnetic layers made of Fe are separated by Ti and Ag is the environmentally-functional material designed for water disinfection. FIG. 2 shows an exemplary hysteresis loop of such synthetic antiferromagnetic nanoparticles measured by alternating gradient magnetometry. When there is no external field, as shown in the position 200, the particles have negligible remanence. When the external field is high enough (positions 202), the moments of the particles are saturated. This is very important because these particles can therefore be magnetized and aggregate around the magnetic pole and later redispersed well in the solution once the external magnetic field is removed.

Water from a contaminated or questionable source can have various contaminants, including micro-organisms and chemicals. These contaminants, although in trace amount sometimes, can cause serious health issue if people drink the water directly. In our design, the functional layers 116 and 118 can be made of different materials, thereby addressing different problems.

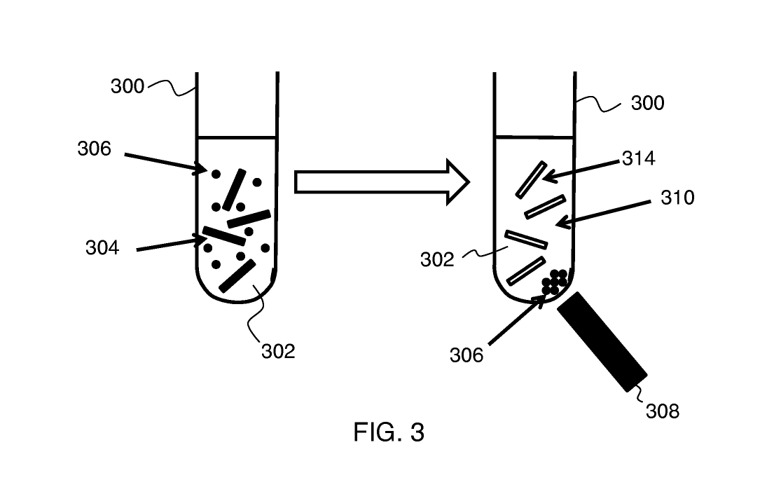

In one embodiment, the functional layers are chosen to be Ag in order to kill pathogens. Ag has long been known to have disinfection capabilities, as people in ancient times use silverware to store their food to retard bacterial growth. The role of Ag in disinfection will be amplified dramatically if Ag is in nanoparticle form and dispersed in water. FIG. 3 shows a schematic of how synthetic nanoparticles having Ag functional layers can work for water disinfection. In a container 300, water 302 includes pathogens 304, and is mixed with Ag-coated synthetic nanoparticles 306. The mixture is incubated for a sufficiently long time for the silver to kill most/all of the pathogens. Then a magnet 308 is placed close to the container and nanoparticles 306 are attracted towards the magnet and forced to aggregate. The bulk part of the solution 310 is thereby sterilized. Although the pathogens remain in the system as dead pathogens 314, the infectivity is lost or much lower. Magnet 308 can be a permanent magnet. Alternatively, any other kind of magnet can be used to provide the magnetic field for separating the nanoparticles.

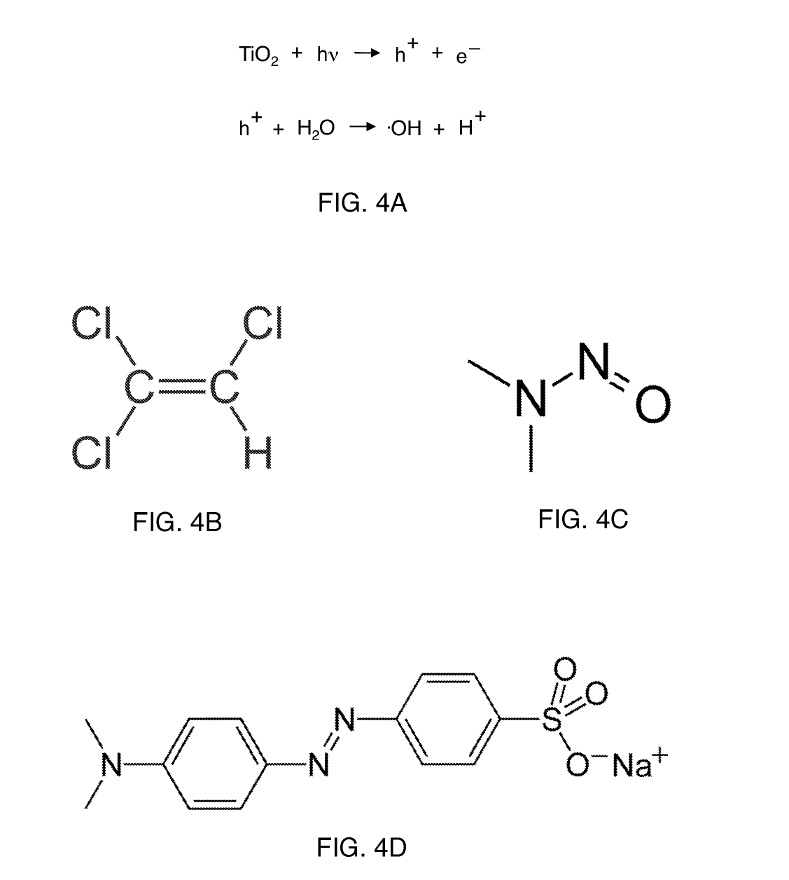

In another embodiment, the functional layers are chosen to be TiO₂ for photocatalytic degradation. TiO₂ can be in amorphous, anatase or rutile phase. Other than micro-organisms, contaminated/questionable water may also include organic compounds that can cause severe health issues. As shown in FIG. 4A, once TiO₂ nanoparticles are dispersed in aqueous solution, under UV irradiation, electron and hole pairs will be generated and further reaction will lead to the generation of hydroxyl radicals. The hydroxyl radicals are found to be capable of degrading many kinds of organic compounds. These compounds can be trichloroethylene (TCE) (FIG. 4B) and N-Nitrosodimethylamine (NDMA) (FIG. 4C), both of which are reported to be carcinogens. They can also be dye molecules (methyl orange for example, FIG. 4D), which can also cause public concern when colored dye solutions are disposed of.

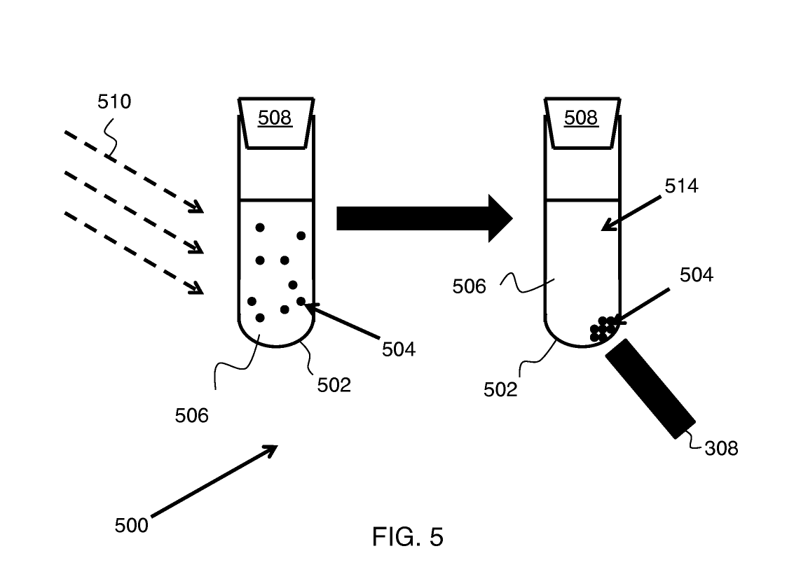

FIG. 5 shows how synthetic nanoparticles having TiO₂ functional layers can work to photo-catalytically degrade organic compounds. In the reaction setup 500, a quartz container 502 is adapted to hold organic-chemical-contaminated water 506 and TiO₂-coated synthetic nanoparticles 504. The quartz container is chosen because it is transparent to UV irradiation and therefore the UV light 510 can interact with the nanoparticles without significant attenuation, thereby initiating the desired reactions. The reaction setup may optionally be sealed with a stopper 508, as in the case of TCE, which is volatile and may cause air pollution if the system is not gas-tight. After a sufficient duration of reaction, the synthetic nanoparticles are then separated by magnet 308, leaving the bulk solution 514 decontaminated and free of nanoparticles.

In a further embodiment, some of the organic compounds are non-degradable, but they can be adsorbed by some oxides. In this case, suitable oxide materials are chosen to be the functionalized layer of the synthetic nanoparticles and we can add these particles into the water source contaminated by those compounds. After those organic compounds are adsorbed to oxide-capped synthetic nanoparticles, we can again use the magnet to separate these nanoparticles from water.

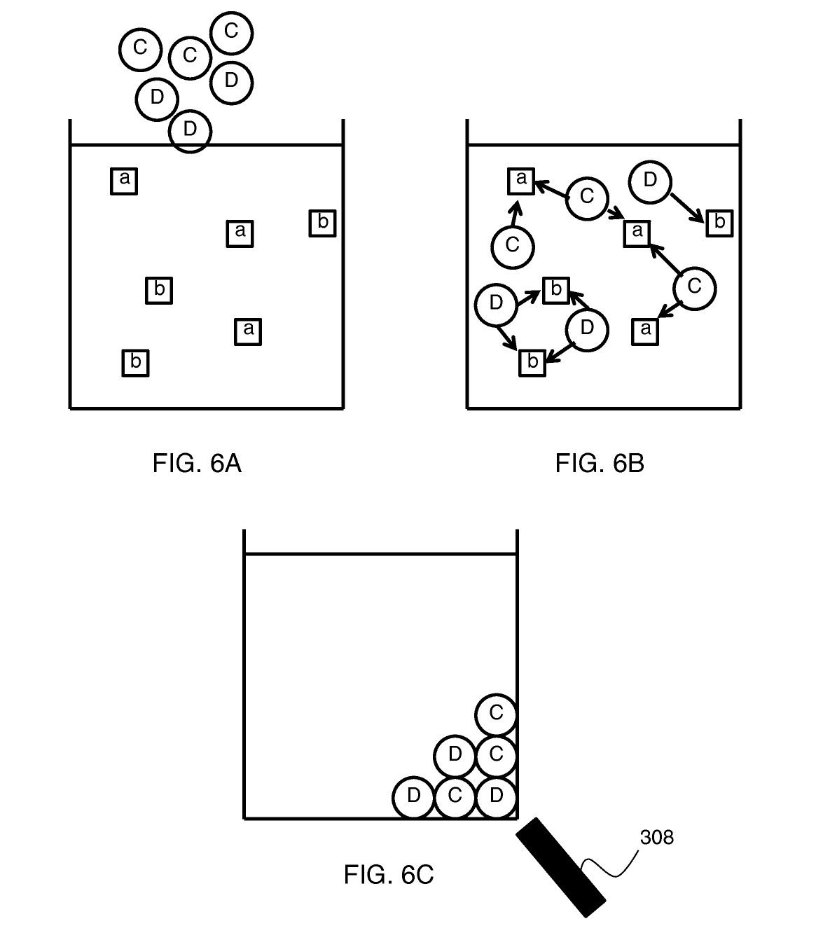

In a preferred embodiment, there are multiple kinds of contaminants in the contaminated/questionable water and each of the contaminants can be removed by one kind of synthetic nanoparticles. As illustrated in FIG. 6A, suppose the water has two contaminants, which are labeled as ‘a’ and ‘b’. These two contaminants are respectively removed by two different synthetic nanoparticles, that is, contaminant ‘a’ is removed by synthetic nanoparticles labeled as ‘C’ and contaminant ‘b’ is removed by synthetic nanoparticles labeled as ‘D’. In this case, a mixture of nanoparticles containing both ‘C’ and ‘D’ are dispersed in the water and incubated for a sufficient duration of time, during which the two kinds of particles will tackle their corresponding contaminants, as shown by arrows in FIG. 6B. Finally, both particles ‘C’ and particles ‘D’ are separated with an external magnet 308, as shown in FIG. 6C. Therefore, both contaminants are removed in a one-pot reaction fashion. In fact, any number of contaminants can be removed simultaneously as long as each of them can be tackled with at least one kind of synthetic nanoparticles.

In many cases, such as Ag for water disinfection and TiO₂ for photo-catalytic degradation, the functional layers will not be consumed significantly after the nanoparticles are used for treating water for the first time. Also, due to the low remanence of the magnetic cores in synthetic nanoparticles, the particles can be redispersed well in aqueous solution once the external magnetic field is removed. These two properties indicate that we can use synthetic nanoparticles regeneratively, making this technique both cost-effective, environmentally friendly and sustainable. Specifically, we can design a reactor containing synthetic nanoparticles and the reaction has two states. At the ‘magnet OFF’ state, water from a contaminated or questionable source fills the reactor and nanoparticles redisperse in the water because there is no external magnetic field. These nanoparticles tackle the contaminants in the water by disinfection, degradation or other means. Then, the reactor switches to the ‘magnet ON’ state, and all the nanoparticles are attracted towards the magnet and aggregate. The treated water is collected for drinking or other purposes. The reactor can be switched between the ‘magnet OFF’ state and the ‘magnet ON’ state repeatedly, producing clean water automatically. There is no need to replace the synthetic nanoparticles except regenerating them periodically to maintain their chemical and photo-catalytic functionality.

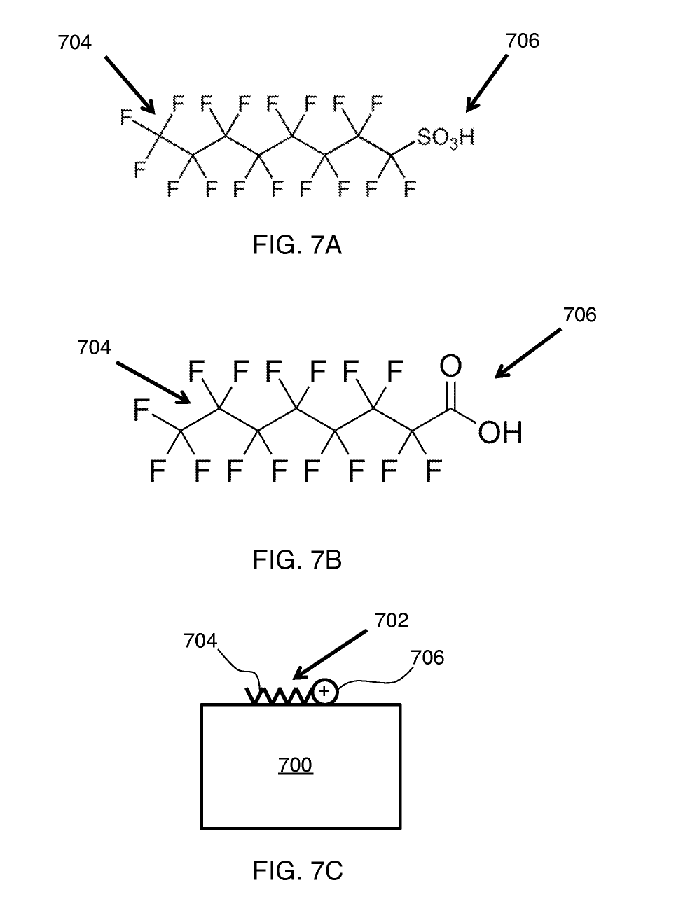

Besides being ideal for magnetic separation, the cores of synthetic nanoparticles have additional properties (e.g., magnetic hyperthermia, see below) suitable for degrading trace chemicals that are otherwise difficult to degrade. Such chemicals include non-degradable and bio-accumulative, perfluorinated compounds (PFCs) which are of increasing public concern. FIG. 7A and FIG. 7B show two typical types of PFCs: perfluorooctane sulfonate (PFOS) and perfluorooctanoic acid (PFOA), respectively. Due to the strong bonding between carbon and fluorine atoms as well as the larger sizes of fluorine atoms compared with that of hydrogen atoms, these molecules can form stiff backbones 704 which are highly non-reactive. Although difficult to degrade by chemical reactions, these molecules reportedly can be destroyed under mechanical interactions. They can also be adsorbed to some oxide surfaces through electrostatic attraction because these molecules have charged head groups 706. Therefore, as illustrated in FIG. 7C, once oxide-capped synthetic nanoparticles 700 are added into water containing PFCs 702, these PFCs will stick to the surface of the nanoparticles, and then the backbones of the absorbed PFCs can be broken in several ways.

In one embodiment, these nanoparticles are dried on a substrate after the adsorption of the PFC molecules. The dried powders can be directly heated up for a sufficient duration until the PFC backbones are broken. In addition, an alternating magnetic field can be applied to generate extra energy in the nanoparticles through a mechanism known as magnetic hyperthermia. Moreover, an RF electromagnetic field can be applied and it can generate eddy currents within the nanoparticles and nanoparticle clusters because their cores are made of metallic materials. Again this extra energy generated by the eddy currents will potentially degrade the PFC molecules.

### EXPERIMENTS

Several experiments have been performed using synthetic nanoparticles described above for water disinfection. Here, the synthetic nanoparticles are 160 nm in diameter and they have layer sequences of: Ag 20 nm/Ti 5 nm/Fe 5 nm/Ti 3 nm/Fe 5 nm/Ti 5 nm/Ag 20 nm. The nanoparticles are designed for treating water sources potentially containing pathogens. Here, we choose E. Coli as the sample pathogen and prepare the water sample by adding E. Coli to DI water.

### Experiment 1

### Magnetic Separation of Ag-Capped Synthetic Nanoparticles

Here, aliquots of synthetic-nanoparticle solution are placed in identical vials. The volume of each sample is 200 μl. A NdFeB magnet is placed underneath each vial and the synthetic nanoparticles are attracted downward in response to the external magnetic field. Each vial is set to have a different magnetic-separation time duration and right after this separation time, 170 μl of the bulk solution is transferred to a new vial, leaving the old vial containing 30 μl of solution. The amounts of particles in both new and old vials are expressed in terms of Ag amount and this amount is measured by inductively-coupled plasma mass-spectrometry (ICPMS). Generally, a known amount of particle solution is mixed with at least equal amount of 70 wt % concentrated nitric acid and incubated overnight. During this time, Ag, Ti and Fe from the particles will all be dissolved into the solution. Then the mixture is further diluted with ultrapure distilled water to a known amount, when the concentrations of these elements are measured by ICPMS.

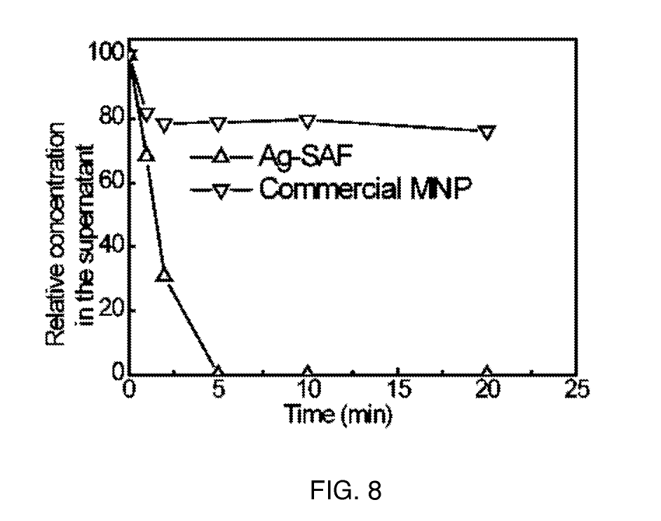

The percentage of particles remaining in the bulk solution is calculated as the ratio between Ag amount in the new vial and the total Ag amount in both old and new vials. The percentages for different samples are plotted vs. the separation time, as shown in FIG. 8. Over 99% of the synthetic antiferromagnetic (Ag-SAF) particles are attracted down by the magnet for samples with separation time longer than 10 min. As a comparison, iron-oxide nanoparticles (SMG-20-0005, Ocean Nanotech LLC) are also used for magnetic separation. These particles are dispersed in water and the same volume of water solution is transferred in each vial and the magnetic separation setup is the same as described above. The percentage of these commercial MNPs (magnetic nanoparticles) left in the bulk solution is also plotted vs. the separation time on FIG. 8. Even after 20 min, the percentage of the particles left in the solution is still higher than 60% and there is no obvious further decrease. The dramatic difference in the results between these two particles comes from the different single-particle magnetic moments they have. With magnetic moments at least one order of magnitude higher than those of iron-oxide nanoparticles, Ag-capped synthetic nanoparticles are much more magnetically responsive.

### Experiment 2

### The Disinfection Effect of Ag-Capped Synthetic Nanoparticles

Here, synthetic nanoparticles with a series of dosages are mixed with water samples with different active E. Coli concentrations. The dosage of the nanoparticles is expressed in terms of the total amount of Ag in the solution, which can be again measured by ICPMS. The active E. Coli concentration is measured by taking a known portion of water sample and spreading it onto an agar plates for culturing. Typically after one day of incubation under 30° C., each active E. Coli cell will reproduce to form a colony and E. Coli concentration in the original sample can be obtained by counting the number of colony forming units (CFUs).

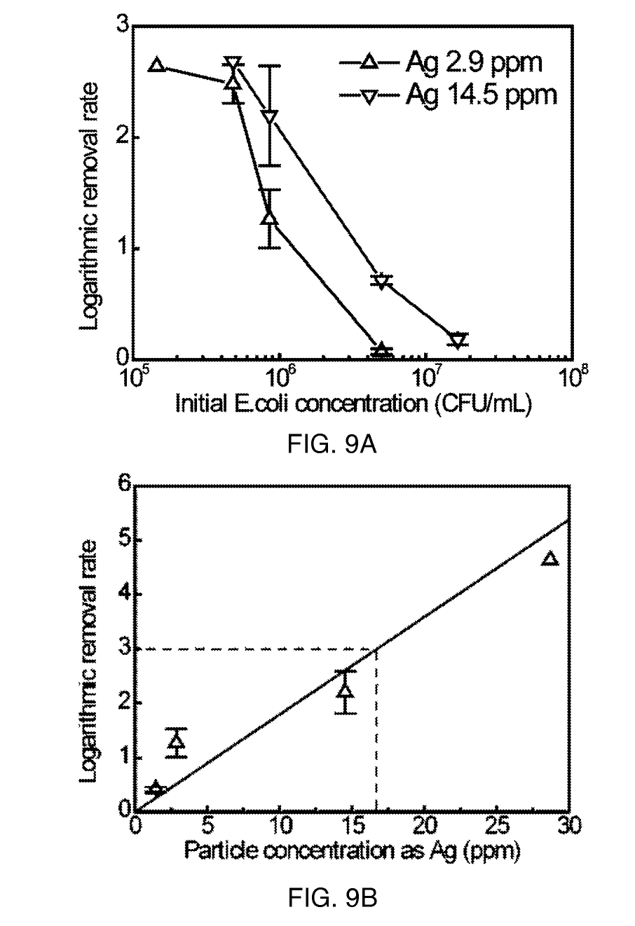

After mixing synthetic nanoparticles with water sample, the solution is set aside for 10 min. Then, the nanoparticles are separated from water using a magnet using the previous setup. The separation time is set to be 10-20 min, since over 99% of nanoparticles can be separated from the bulk solution within this amount of time according to the previous result. The disinfection effect is characterized by the removal rate after disinfection, which is the ratio between the inactivated E. Coli number and the total E. Coli number. FIG. 9A is the removal rate in relation to the initial E. Coli concentration at two different nanoparticle dosages. Generally the removal rate will increase when the initial concentration of E. Coli decreases. When the Ag concentration is 2.9 ppm, we can get over 99% active E. Coli removal rates when the initial concentration is below 7×10⁵ CFUs/ml; and when the Ag concentration is raised to 14.9 ppm, we can get over 99% active E. Coli removal rates even when the initial E. Coli concentration reaches 10⁶/ml. FIG. 9B is the ratio of active E. Coli left in dependence of the dosage when the initial E. Coli concentration is set to be 10⁶ CFUs/ml. The ratios of active E. Coli left in log scale reveal more encouraging results as the removal rate plotted in FIG. 9A cannot demonstrate the different between 99% and 99.9%. More nanoparticles reacting with E. Coli will result in less active E. Coli surviving after the reaction. Here, the result shows that at an Ag concentration of 30 ppm, the log (removal rate) is approaching 5, which in other words means over 99.99% of the original E. Coli are killed. A logarithmic removal rate of 3 is reached at a particle concentration of 17 ppm as Ag.

### Experiment 3

### Regenerative Water Disinfection Using Same Batch of Ag-Capped Synthetic Nanoparticles

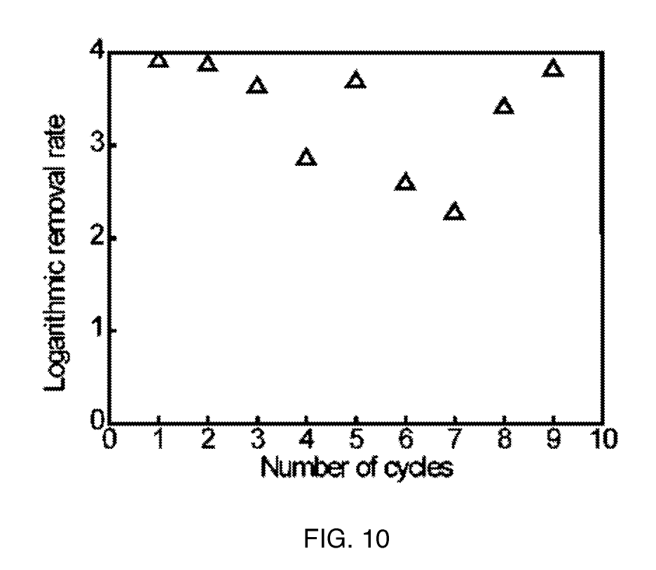

In the previous two experiments, Ag-capped synthetic nanoparticles have shown encouraging performance for both magnetic separation and water disinfection. Also in the previous work, we show that these synthetic nanoparticles can be redispersed well in water once the external magnetic field is removed. These important aspects are the building blocks for a practical portable point-of-use water disinfection device, where nanoparticles are used regeneratively. Here, in order to demonstrate the regenerative use of Ag-capped synthetic nanoparticles, a certain amount of nanoparticles is mixed with DI water containing E. Coli for the first cycle to make a total solution volume of 1 ml, where the Ag concentration is 14.4 ppm. This setup is incubated for 20 min and a magnet is used to separate the particles from bulk solution for 20 min. Then 900 μl of the bulk solution is removed, followed by the addition of 900 μl fresh DI water containing E. Coli. And again this setup is incubated for 20 min in order to start the second cycle and the process is repeated for 9 cycles. In all of these cycles, the initial E. Coli concentration is varying above 10⁵/ml level. FIG. 10 shows the effect of water disinfection after different cycles. Here, the y-axis is the log (removal rate). For each of the 9 cycles, more than 99% of E. Coli are killed and the average removal rate stays around 99.9%. Therefore, Ag-capped synthetic nanoparticles are capable of regeneratively disinfecting water, making the portable point-of-use water disinfection device promising.

### EXEMPLARY EMBODIMENTS

### Embodiment 1

A synthetic nanoparticle with a multi-layered disk-shaped structure, where the diameter of the synthetic nanoparticle in is a range from 50 nm to 200 nm. Here the synthetic nanoparticle includes: a) a multi-layered synthetic antiferromagnetic core; and b) environmentally functional layers on at least one side of the magnetic core.

### Embodiment 2

### Variations on Embodiment 1

The magnetic core can include a layer stack C/F/S/F/C, where F stands for ferromagnetic layers (same or different materials), S stands for a non-magnetic spacer layer, and C stands for capping layers (same or different materials). Suitable materials for the S layer include, but are not limited to: ruthenium and titanium. Preferably, the thickness of the S layer is 10 nm or less. Suitable materials for the F layers include, but are not limited to: iron and cobalt-iron alloys. Preferably, the F layers have a thickness ranging from 5 nm to 30 nm. Suitable materials for the C layers include but are not limited to: titanium. Preferably, the C layers have a thickness ranging from 3 nm to 10 nm. Preferably, the environmentally functional layer (or layers) has a thickness ranging from 10 nm to 50 nm.

### Embodiment 3

### Disinfection

Suitable materials for the environmentally functional layer (or layers) include, but are not limited to: silver. Such silver-containing nanoparticles are suitable for water disinfection. For example, a disinfection method can include: i) adding the synthetic nanoparticles into water source containing micro-organisms, and incubating for a certain amount of time; and ii) magnetically separating the synthetic nanoparticles from the water source, and leaving the water disinfected and free of synthetic nanoparticles.

### Embodiment 4

### Degradation

Suitable materials for the environmentally functional layer (or layers) include, but are not limited to: titanium dioxide, in the form of rutile, anatase or amorphous phase. Such nanoparticles are suitable for photodegradation of hazardous organic compounds. For example, a remediation method can include: i) adding the synthetic nanoparticles into water source containing hazardous organic compounds, and incubating for a certain amount of time while irradiating with ultraviolet light; and ii) magnetically separating the synthetic nanoparticles from the water source, and leaving the hazardous organic compounds degraded and the water free of synthetic nanoparticles. This approach is suitable for remediation of compounds such as: trichloroethylene and its derivatives, N-Nitrosodimethylamine and its derivatives, dye molecules, or other organic compounds.

### Embodiment 5

### Handling Non-Degradable Compounds

Suitable materials for the environmentally functional layer (or layers) include, but are not limited to: silica or metal oxides. Such nanoparticles are suitable for remediation of non-degradable organic compounds. For example, a remediation method can include: i) adding the synthetic nanoparticles into a water source containing non-degradable organic compounds, and incubating for a certain amount of time; and ii) magnetically separating the synthetic nanoparticles from the water source, and leaving the water free of both synthetic nanoparticles and non-degradable organic compounds. Further processing can break down non-degradable compounds, e.g., by heating or hyperthermia. For example, a method can include: i) adding the synthetic nanoparticles into water source containing non-degradable perfluorinated compounds, and incubating for certain amount of time; ii) magnetically separating the synthetic nanoparticles from the water source, and leaving the water free of both synthetic nanoparticles and perfluorinated compounds; and iii) drying the particles out on a substrate after they are separated from the bulk water source, and applying an external alternating magnetic field (hysteresis loss heating), heat, external RF electromagnetic field (to induce eddy currents which heat the nanoparticles) or other means to introduce extra energy to break the backbone of the perfluorinated compounds.

### Embodiment 6

### Simultaneous Multiple Treatment Modes

The treatment approaches of embodiments 3, 4 and 5 can be practiced individually or in any combination. For example, multiple kinds of nanoparticles can be employed to simultaneously disinfect, degrade and/or segregate biological and/or chemical contaminants in water. For example, a method can include: i) adding all kinds of synthetic nanoparticles together into a water source possibly containing micro-organisms as well as degradable and non-degradable organic compounds, and incubating for certain amount of time, including irradiation with ultraviolet light if/as needed; and ii) magnetically separating the synthetic nanoparticles from the water source, and leaving the water disinfected and free of synthetic nanoparticles as well as degradable and non-degradable hazardous organic compounds.

### Embodiment 7

### Regeneration of Nanoparticles

In practicing embodiments 1-6, the nanoparticles can be used in a regenerative manner. For example, a treatment method can include: i) adding all kinds of synthetic nanoparticles together into a water source possibly containing micro-organisms as well as degradable and non-degradable organic compounds, and incubating for a certain amount of time, including irradiation with ultraviolet light if/as needed; ii) magnetically separating the synthetic nanoparticles from the water source, and leaving the water disinfected and free of synthetic nanoparticles as well as degradable and non-degradable hazardous organic compounds; and iii) redispersing the synthetic nanoparticles after they are separated from bulk water source and adding them into new water source containing micro-organisms as well as degradable and non-degradable organic compounds and repeating the process starting from

### Embodiment 8

### Treatment Timing

In any of the preceding methods, the incubation time can be between 10 minutes and two days, according to the different situations. The magnetic separation time can be between 10 minutes and 5 hours, according to the different situations.

1. Apparatus for the treatment of water, the apparatus comprising:
a plurality of synthetic antiferromagnetic nanoparticles, each of the nanoparticles including a first ferromagnetic layer, a second ferromagnetic layer and a non-magnetic spacer layer sandwiched between the first and second ferromagnetic layers;
wherein one or more surfaces of the nanoparticles are coated with one or more functional layers for water treatment.

2. The apparatus of claim 1:
wherein the non-magnetic spacer layer comprises ruthenium or titanium, wherein the non-magnetic spacer layer has a thickness of about 10 nm or less;
wherein the ferromagnetic layers comprise iron or a cobalt-iron alloy, and wherein the ferromagnetic layers have thicknesses in a range from about 5 nm to about 30 nm.

3. The apparatus of claim 1, wherein the nanoparticles further comprise one or more capping layers sandwiched between the functional layers and the ferromagnetic layers, wherein the capping layers comprise titanium, and wherein the capping layers have thicknesses in a range from about 3 nm to about 10 nm.

4. A method for treatment of water, the method comprising:
providing a plurality of synthetic antiferromagnetic nanoparticles, each of the nanoparticles including a first ferromagnetic layer, a second ferromagnetic layer and a non-magnetic spacer layer sandwiched between the first and second ferromagnetic layers, wherein one or more surfaces of the nanoparticles are coated with one or more functional layers for water treatment;
dispersing the nanoparticles in water to be treated; and
separating the nanoparticles from the water using an applied magnetic field to provide treated water that is substantially free of the nanoparticles.

5. The method of claim 4, wherein the functional layers comprise silver and have thicknesses in a range from about 10 nm to about 50 nm, wherein the water to be treated includes micro-organisms, and wherein the nanoparticles are dispersed in the water to be treated for an incubation time, whereby disinfection of the water to be treated is provided.

6. The method of claim 4, wherein the functional layers comprise titanium oxide, wherein the water to be treated includes organic compounds, and wherein the nanoparticles are dispersed in the water to be treated for an incubation time while being illuminated with ultraviolet light, whereby photo-catalytic degradation of the organic compounds is provided.

7. The method of claim 4, wherein the functional layers comprise silica or a metal oxide, wherein the water to be treated includes organic compounds, and wherein the nanoparticles are dispersed in the water to be treated for an incubation time to adsorb the organic compounds onto the functional layers, whereby removal of the organic compounds from the water is provided.

8. The method of claim 7, further comprising providing heat to the nanoparticles to degrade adsorbed organic compounds, wherein the heat is provided by a method selected from the group consisting of: inducing magnetic hyperthermia with an applied alternating magnetic field, and inducing eddy current flow with an applied radio-frequency electromagnetic field.

9. The method of claim 4, wherein the functional layers are configured to provide two or more treatment modes selected from the group consisting of: disinfection, photo-catalytic degradation of organic compounds, and adsorption of organic compounds, whereby simultaneous multi-mode water treatment is provided.

10. The method of claim 4, further comprising collecting the separated nanoparticles for re-use in one or more subsequent water treatments including magnetic separation of the nanoparticles from water.
